(19) United States
(12) Patent Application Publication
(10) Pub. No.: US 2019/0013110 A1
(43) Pub. Date: Jan. 10, 2019

(54) Conductive Fine Particles and Method for Producing Conductive Fine Particles

(71) Applicant: SANNO Co., Ltd., Yokohama-shi, Kanagawa (JP)

(72) Inventors: Satoshi YAEGASHI, Yokohama-shi, Kanagawa (JP); Takayuki MAEHATA, Kooriyama-shi, Fukushima (JP)

(21) Appl. No.: 16/067,741

(22) PCT Filed: Nov. 15, 2016
(86) PCT No.: PCT/JP2016/083827

§ 371 Date: Jul. 2, 2018

(30) Foreign Application Priority Data
Jan. 13, 2016 (JP) 2016-004611

(51) Int. Cl. H01B 1/12; H01B 1/22; C23C 18/42; C23C 18/32; C23C 18/52; C23C 18/20

(52) U.S. Cl. CPC H01B 1/12; H01B 1/22; C23C 18/2073; C23C 18/32; C23C 18/52; C23C 18/42

(57) ABSTRACT

The conductive fine particles according to the present invention each have: a core particle containing an acrylic resin; and a silver layer provided directly on the surface of the core particle directly or provided on the surface of the core particle via a nickel layer, wherein the surface coverage rate of the silver layer is 70% or higher.

### TECHNICAL FIELD

The present invention relates to conductive fine particles and a method for producing conductive fine particles.

### BACKGROUND ART

Conductive fine particles are used for an anisotropic conductive material and the like. Such conductive fine particles of a well-known type are those which include: resin particles as core particles; and metal layers formed on the core particles. Styrenic resin particles and acrylic resin particles, for example, are known as the resin particles. On the other hand, the metal layers generally have a structure in which gold layers are provided on nickel layers as an undercoat.

In connection with the above, for example, Japanese Patent No. 3561748 discloses conductive particles which are obtained by: electrolessly plating nickel on resin particles; and thereafter electrolessly plating gold on the resultant resin particles (see Example). Meanwhile, Japanese Patent Application Publication No. Hei 8-325543 and Japanese Patent No. 3587398 also disclose that conductive particles are formed by: forming nickel layers on resin particles; and further forming gold layers in the resultant resin particles.

Gold, however, is expensive, and there has been a demand for an alternative material to gold. A conceivable example of the alternative material to gold is silver. With regard to conductive fine particles using silver, for example, Japanese Patent No. 3832938 discloses an electroless silver-plated powder whose base materials are copper-covered particles each including an undercoat layer of a nickel-plated film, and which includes silver films formed on the surfaces of the base materials using an electroless plating method for forming the silver films by replacement reaction between copper and silver.

### CITATION LIST

### Patent Literatures

### Patent Literature 1: Japanese Patent No. 3561748

Patent Literature 2: Japanese Patent Application Publication No. Hei 8-325543

### Patent Literature 3: Japanese Patent No. 3587398

### Patent Literature 4: Japanese Patent No. 3832938

### SUMMARY OF INVENTION

It is however difficult to form the silver layers on the core particles directly or with the nickel layers in between by plating. For example, as described in Japanese Patent No. 3832938 (Patent Literature 4), provision of the copper layers between the nickel layers and the silver layers and the like are needed to form the silver layers on the nickel layers. This method requires a step of providing the copper layers to be added to the production process, and accordingly makes impossible to obtain the conductive fine particles at lower costs.

Meanwhile, in a case where styrenic resin particles are used as the core particles, the surfaces of the resin particles can be roughened using chemicals, and the adhesion of the metal layers formed on the resin particles can be increased with an anchoring effect. The styrenic resin, however, is expensive. On the other hand, in a case where a less expensive acrylic resin is used as the core particles, it is difficult to appropriately roughen the resin fine particles because of high chemical resistance of the acrylic resin.

The use of the acrylic resin particles as the core particles accordingly makes it more difficult to form dense silver layers on the resin particles directly or with the nickel layers in between.

In view of the above, an object of the present invention is to provide conductive fine particles or a method for producing the same, which is able to form a dense silver layer on the core particle directly or via a nickel layer, when the core particle contains an acrylic resin.

The present inventors have found that the above problems can be solved by treating the core particle containing acrylic resin with a solution containing surfactant. To put it specifically, the present invention includes the followings.

(1) A conductive fine particle including: a core particle containing acrylic resin; and a silver layer provided on a surface of the core particle, directly or with a nickel layer in between, wherein a surface coverage of the silver layer is 70% or more.
(2) The conductive fine particle described in the above (1), wherein a number average particle diameter is 1 μm to 100 μm.
(3) A method for producing a conductive fine particle, including the steps of: treating a core particle containing acrylic resin with a solution containing surfactant; and forming a silver layer on the core particle treated with the surfactant, using an electroless silver plating solution.
(4) The method for producing a conductive fine particle described in the above (3), further including, before the step of forming a silver layer, the step of forming a nickel layer on the core particle treated with the surfactant, using an electroless nickel plating solution.
(5) The method for producing a conductive fine particle described in the above (3) or (4), wherein a concentration of the surfactant is 0.5 g/L to 20 g/L.
(6) The method for producing a conductive fine particle described in any one of the above (3) to (5), wherein the surfactant is aminocarboxylate.
(7) The method for producing a conductive fine particle described in any one of the above (3) to (6), wherein the electroless silver plating solution is a non-cyan electroless silver plating solution.

The present invention provides: the conductive fine particle which uses the core particle containing the acrylic resin, and in which the dense silver layer can be formed on the core particle directly or with the nickel layer in between; and the method of producing the same.

### BRIEF DESCRIPTION OF DRAWINGS

FIG. 1A shows a scanning electron micrograph of conductive fine particles according to Comparative Example.

FIG. 1B shows a scanning electron micrograph of conductive fine particles according to Example.

FIG. 2 shows diagrams showing results of measuring surface coverages of the conductive fine particles according to Comparative Example.

FIG. 3 shows diagrams showing a result of measuring surface coverage of the conductive fine particles according to Example.

### DESCRIPTION OF EMBODIMENT

Descriptions will be hereinbelow provided for an embodiment of the present invention.

### (1) Conductive Fine Particles

Conductive fine particles according to the embodiment each includes a core particle containing acrylic resin, and a sliver layer provided to the surface of the core particle. The sliver layer is directly provided to the surface of the core particle. Otherwise, a nickel layer serving as an undercoat may be provided between the silver layer and the core particle.

In this respect, a surface coverage of the silver layer is 70% or more, preferably 80% more, and more preferably 95% or more. Conductive particles with such a surface coverage can be obtained using a production method, which will be described later.

In the present invention, the “surface coverage” is a ratio of a region that the silver layer covers to a total region that the surface of the core particle occupies. The surface coverage can be got, for example by obtaining a scanning electron micrograph. To put it specifically, the region that the silver layer covers can be got by: obtaining an image of a conductive fine particle using a scanning electron microscope; and applying a binarization process to the obtained image. Thereafter, the surface coverage can be obtained by dividing the area of the region that the silver layer covers by the total area of the core particle.

The acrylic resin to be used as a core particle is a resin particle obtained by polymerizing monomers containing (meth)acrylic acid ester as a principal component (50 wt % or more, preferably 70 wt % or more, and more preferably 90 wt % or more). For example, at least one compound selected from the group consisting of methyl (meth)acrylate, ethyl (meth)acrylate, propyl (meth)acrylate, butyl (meth)acrylate, 2-ethylhexyl (meth)acrylate, lauryl (meth)acrylate, stearyl (meth)acrylate, cyclohexyl (meth)acrylate, 2-hydroxyethyl (meth)acrylate, 2-propyl (meth)acrylate, chloro-2-hydroxyethyl (meth)acrylate, diethylene glycol mono(meth)acrylate, methoxyethyl (meth)acrylate, glycidyl (meth)acrylate, dicyclopentanyl (meth)acrylate, dicyclopentenyl (meth)acrylate, and isoboronol (meth)acrylate may be used as the (meth)acrylic acid ester.

The monomer component (s) of the acrylic resin may contain a slight amount of different monomer. Such a different monomer component includes a styrenic monomer.

A number average particle diameter of the conductive fine particles is not specifically limited, and is 1 μm to 100 μm.

The conductive fine particles according to the embodiment have a very low volume resistance value since each core particle is covered with the silver layer at a high surface coverage. The conductive fine particles according to the embodiment, therefore, are effective as conductive fine particles for an anisotropic conductive material, for example.

### (2) Method for Producing Conductive Fine Particles

The method for producing conductive fine particles includes the steps of: treating core particles containing acrylic resin with a solution containing surfactant; and forming the silver layer on each core particle treated with the surfactant, using an electroless silver plating solution. This method can impart wettability to the core particles since the method treats the core particles with the surfactant. The imparting of the wettability makes it possible to increase adhesion of the metal layer formed on each core particle.

Descriptions will be hereinbelow provided for the method for producing conductive particles in which the silver layer is formed on each core particle with a nickel layer in between.

### 1. Pre-Treatment

To begin with, as raw materials, the core particles are treated with the solution containing the surfactant. To put it specifically, the core particles are soaked into, and agitated in, the solution or preferably aqueous solution which contains the surfactant.

The surfactant is not specifically limited, but amphoteric surfactant, anionic surfactant, cationic surfactant and nonionic surfactant can be used as the surfactant. Amphoteric surfactant is preferably used as the surfactant.

The usable amphoteric surfactant includes aminocarboxylate, carboxy betaine type amphoteric surfactant, sulfobetaine type amphoteric surfactant, imidazolinium betaine type amphoteric surfactant, and alkyl amine oxide. Aminocarboxylate is preferably used as the amphoteric surfactant.

The usable anionic surfactant includes polyoxyethylene alkyl sulfate, alkyl or alkenyl sulfate, polyoxyethylene alkyl or alkenyl sulfate ester salt, alkyl sulfonate, α-olefin sulfonate, alkyl benzene sulfonate, alkyl ether sulfate or alkenyl ether sulfate, and alkyl or alkenyl ether carboxylate.

The usable cationic surfactant includes alkylamine salts, quaternary ammonium salts, polyoxyethylene alkyl amine salts, and polyethylene polyamine derivatives.

The usable nonionic surfactant includes polyoxyethylene alkyl ether, polyoxyethylene glycerin fatty acid ester, ethylene glycol fatty acid ester, and polyoxyethylene fatty acid amide.

Furthermore, auxiliary materials such as silicate may be contained in the surfactant solution.

The concentration of the surfactant in the solution is, for example 0.5 g/l to 20 g/L, and preferably 5 g/L to 15 g/L.

In addition, the temperature of the surfactant solution is, for example 10 to 70° C., preferably 20 to 50° C., and more preferably 30 to 40° C.

A length of time for the treatment using the surfactant is, for example 1 to 60 minutes, preferably 3 to 20 minutes, and more preferably 5 to 15 minutes.

It should be noted that publicly-known other pre-treatments may be performed before the treatment using the surfactant. Such other pre-treatments include a swelling treatment using an aqueous alcohol solution, an etching treatment using an alkaline aqueous solution, and an etching treatment using an acidic aqueous solution.

The acidic aqueous solution usable for the etching treatment includes an aqueous solution in which an oxidant (for example, permanganate such as potassium permanganate, or chromate such as sodium chromate or potassium chromate) is dissolved in an aqueous sulfuric solution.

### 2. Catalyzing

After the treatment using the surfactant, a catalytic treatment is performed on the core particles. The method for the catalytic treatment is not specifically limited. For example, the core particles are soaked into a mixed solution of palladium chloride and tin chloride, and thereafter, tin is selectively removed using an acidic or alkaline solution. This makes it possible for the core particles to carry palladium. Furthermore, the catalyst may be activated by treating the core particles with an aqueous solution containing a reducing agent after the catalytic treatment.

### 3. Electroless Nickel Plating

Subsequently, the core particles are soaked into an electroless nickel plating solution to form the nickel layer on each core particle. The electroless nickel plating solution is not specifically limited. For example, an aqueous solution containing water-soluble nickel salt as a nickel source, a pH modifier, a reducing agent and the like may be used as the electroless nickel plating solution. The water-soluble nickel salt includes nickel sulfate, nickel chloride, nickel acetate, and nickel hypophosphite. The pH modifier includes ammonium. The reducing agent includes sodium hypophosphite, sodium borohydride, potassium borohydride, dimethylamine borane, hydrazine, and formalin. Incidentally, after the nickel layer is deposited by soaking the core particles into the electroless nickel solution containing the water-soluble nickel salt and the pH modifier, the reduction treatment may be performed by adding the reducing agent to the aqueous solution.

### 4. Electroless Silver Plating

Next, the core particles are soaked into the electroless silver plating solution to form the silver layer. The electroless silver plating solution is not specifically limited. A commercially-available electroless silver plating solution may be used. For example, a solution containing water-soluble silver salt as a silver source and a complexing agent is used as the electroless silver plating solution. The water-soluble silver salt includes silver nitrate, silver sulfate salt, and silver cyanide. Incidentally, it is preferable that non-cyan silver salt such as silver nitrate and silver sulfate be used.

The complexing agent is not particularly limited, and includes formaldehyde, acetamide, oxamine, succinimide, sulfurous acid, sulfite, citric acid, and ammonium.

The conductive fine particles in which the silver layer is formed on each core particle with the nickel layer in between are obtained using the above-discussed method. Incidentally, in a case where the electroless silver plating process is performed without performing the electroless nickel plating process after the catalytic treatment process (catalyzing), the conductive fine particles in which the silver layer is formed directly on each core particle can be obtained.

The method according to the embodiment makes it possible to form the dense metal layer with high adhesion on each core particle since the method treats the core particle with the surfactant. The method, therefore, makes it possible to obtain the conductive fine particles on each of which the silver layer is formed at high surface coverage, and accordingly to reduce a resistance value of the conductive fine particles remarkably.

Example of the present invention will be hereinbelow described for the purpose of clarifying the invention in detail.

### EXAMPLES

As the core particles, acrylic resin particles with a number average particle diameter of 6.5 μm were soaked into an aqueous methanol solution, and were thereby swollen. After the swelling, the surfaces of the core particles were pre-etched by adding an aqueous sodium hydroxide solution to the aqueous methanol solution.

Thereafter, the core particles were filtered off. The filtered-off core particles were soaked and agitated in an acidic aqueous solution at 80° C. for 80 minutes to etch the surfaces of the core particles. As the acidic aqueous solution, a solution obtained by mixing 192.4 ml of pure water, 8.0 ml of sulfate, and 2.4 mg of potassium permanganate together was used for the etching.

After filtered off, the core particles were acid-washed with another acidic aqueous solution (an aqueous solution of hydrochloric acid and hydrogen peroxide). The acid-washed core particles were soaked and agitated in an aqueous surfactant solution at 35° C. for 10 minutes, followed by being filtered off. The aqueous surfactant solution in use was obtained by diluting an aqueous solution containing 10-percent aminocarboxylate and 5-percent silicate to a concentration of 100 ml/L.

After that, the core particles were soaked into a catalyst solution (a mixed solution of palladium chloride and tin chloride). Subsequently, the core particles were treated with an aqueous hydrochloric acid to make the core particles bear palladium as the catalyst. Then, the core particles were filtered off.

Thereafter, the core particles were soaked into a commercially-available nickel plating solution containing nickel salt and a reducing agent to deposit the nickel layer on each core particle. After deposition, the deposited nickel layer was reduced by adding a reducing agent. After the reduction, the particles were filtered off.

Subsequently, the particles were soaked into a commercially-available non-cyan electroless silver plating solution to form the silver layers on the nickel layers. The particles on which the silver layers were formed were filtered off, and were washed with methanol. After that, the resultant particles were dried to obtain the conductive fine particles according to Example.

### Comparative Example

Conductive fine particles according to Comparative Example were obtained using the same way as those according to Example, except that neither the etching with the acidic aqueous solution (containing sulfate and potassium permanganate) nor the treatment with the surfactant was performed.

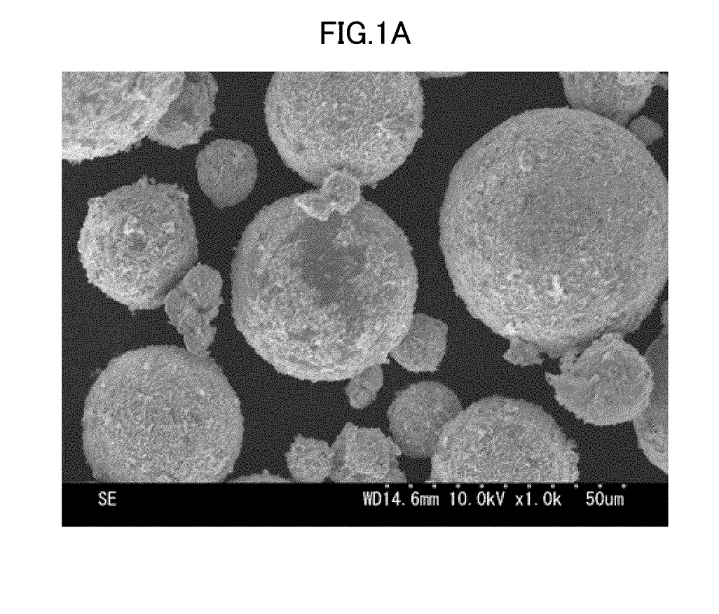

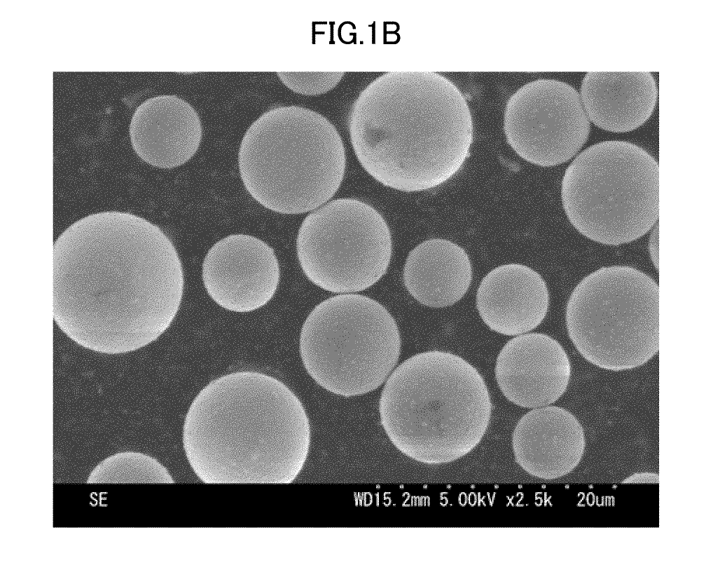

The conductive fine particles according to Example and the conductive fine particles according to Comparative Example were observed using a scanning electron microscope. FIG. 1A shows a scanning electron micrograph of the conductive fine particles according to Comparative Example. FIG. 1B shows a scanning electron micrograph of the conductive fine particles according to Example. As shown in FIG. 1A, as for the conductive fine particles according to Comparative Example, parts of the silver layers were separate from the core particles, and the surfaces of the core particles were inhomogeneous. In contrast, as shown in FIG. 1B, as for the conductive fine particles according to Example, the entirety of each core particle was evenly covered with the silver layer. From this, it can be learned that the treatment of the core particles with the surfactant made it possible to obtain the dense silver layers with high adhesion.

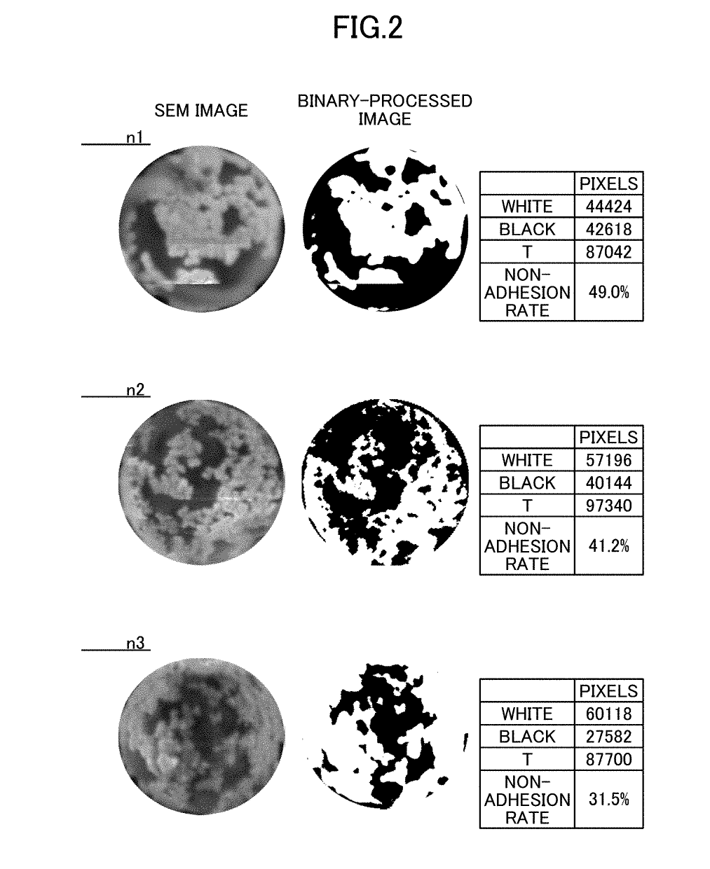

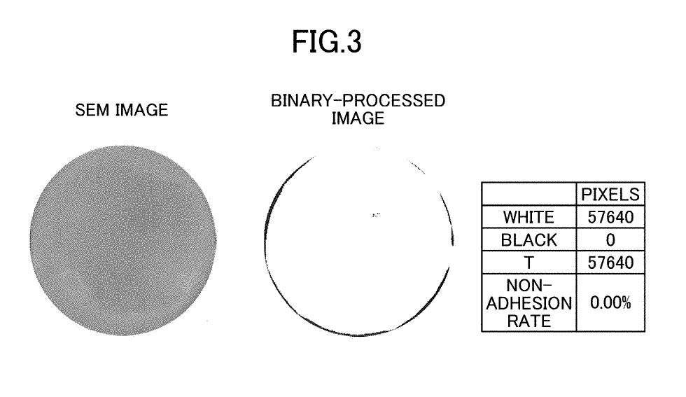

Furthermore, SEM images of the conductive fine particles according to Comparative Example, and an SEM image of the conductive fine particles according to Example were binary-processed. For each binary-processed SEM image, a ratio of black pixels to the total of pixels was obtained as a non-adhesion rate. FIG. 2 shows diagrams showing results of measurements of a surface coverage in Comparative Example. FIG. 3 shows diagrams showing a result of a measurement of a surface coverage in Example. Incidentally, for Comparative Example 2, the surface coverage of the conductive fine particles was measured three times. The results of the measurements showed that the non-adhesion rate in Comparative Example was in a range of 31.5 to 49.0% (in other words, the surface coverage was in a range of 51.0 to 68.5%) while the non-adhesion rate in Example was 0.0% (in other words, the surface coverage was 100%).

Thereafter, a resistance value of the conductive fine particles according to Example, and a resistance value of the conductive fine particles according to Comparative Example were measured. To put it specifically, for each of Example and Comparative Example, 0.58 ml of conductive fine particles was collected as a sample, and the resistance value of the sample conductive fine particles was measured with the sample squeezed between a pair of electrode plates at a load of 20 kgf, by applying a voltage between the electrode plates. Each sample was measured three times, and an average of three measurements was obtained as the resistance value for each sample. The results of the measurements showed that the resistance value of the conductive fine particles according to Example was 159 mΩ while the resistance value of the conductive fine particles according to Comparative Example was 4436 mΩ. In short, the resistance value of the conductive fine particles according to Example was more than 10 less than that of the conductive fine particles according to Comparative Example, and it was accordingly confirmed that the conductive fine particles according to Example had preferable conductive properties.

1. A conductive fine particle comprising:
a core particle containing an acrylic resin; and
a silver layer provided on a surface of the core particle, directly or via a nickel layer, wherein
a surface coverage of the silver layer is 70% or more.

2. The conductive fine particle according to claim 1, wherein a number average particle diameter is 1 μm to 100 μm.

3. A method for producing a conductive fine particle, comprising:
treating a core particle containing an acrylic resin with a solution containing a surfactant; and
forming a silver layer on the core particle treated with the surfactant, using an electroless silver plating solution.

4. The method for producing a conductive fine particle according to claim 3, further comprising:
forming a nickel layer on the core particle treated with the surfactant using an electroless nickel plating solution, before said forming silver layer.

5. The method for producing a conductive fine particle according to claim 3 or wherein a concentration of the surfactant is 0.5 g/L to 20 g/L.

6. The method for producing a conductive fine particle according to claim 3, wherein the surfactant is aminocarboxylate.

7. The method for producing a conductive fine particle according to claim 3, wherein the electroless silver plating solution is a non-cyan electroless silver plating solution.

8. The conductive fine particle according to claim 1, wherein there is no tin layer on the core particle.

9. The conductive fine particle according to claim 1, wherein the core particle carries a catalyst.

10. The conductive fine particle according to claim 1, wherein the catalyst comprises palladium.

11. The conductive fine particle according to claim 1, wherein the surface coverage of the silver layer is 95% or more.

12. The conductive fine particle according to claim 1, wherein the acrylic resin comprises a component derived from at least one compound selected from a group consisting of methyl (meth)acrylate, ethyl (meth)acrylate, propyl (meth)acrylate, butyl (meth)acrylate, 2-ethylhexyl (meth)acrylate, lauryl (meth)acrylate, stearyl (meth)acrylate, cyclohexyl (meth)acrylate, 2-hydroxyethyl (meth)acrylate, 2-propyl (meth)acrylate, chloro-2-hydroxyethyl (meth)acrylate, diethylene glycol mono(meth)acrylate, methoxyethyl (meth)acrylate, glycidyl (meth)acrylate, dicyclopentanyl (meth)acrylate, dicyclopentenyl (meth)acrylate, and isoboronol (meth)acrylate.

13. The method according to claim 3, further comprising:
treating the core particle so that the core particle carries a catalyst, after the treating the core particle with the solution containing the surfactant.

14. The method according to claim 13, wherein the treating the core particle so that the core particle carries the catalyst comprises: soaking the core particle into a mixed solution of palladium chloride and tin chloride, and selectively removing tin from the core particle after the soaking.

15. The method according to claim 14, wherein the tin is selectively removed from the core particle using an acidic or alkaline solution.

16. The method according to claim 3, further comprising:
subjecting the core particle to a swelling treatment using an aqueous alcohol solution, before the treating core particle with the solution containing the surfactant.

17. The method according to claim 16, further comprising:
pre-etching a surface of the core particle with an aqueous sodium hydroxide solution, after the swelling treatment and before the treating core particle with the solution containing the surfactant.

18. The method according to claim 17, further comprising:
etching the surface of the core particle with an aqueous acidic solution, after the pre-etching and before the treating core particle with the solution containing the surfactant.

19. The method according to claim 3, wherein the treating the core particle with the solution containing a surfactant is performed for 1 to 60 minutes.

20. The method according to claim 3, wherein a temperature of the solution containing the surfactant is 10 to 70° C.
